(19) United States
(12) Patent Application Publication
(10) Pub. No.: US 2026/0157378 A1
(43) Pub. Date: Jun. 11, 2026

(54) PROCESS FOR THE PREPARATION OF COMPOSITIONS BASED ON AMINO ACIDS AND PEPTIDES OF ANIMAL ORIGIN AND IODINE, COMPOSITIONS THUS OBTAINED AND USE THEREOF

(71) Applicant: SICIT GROUP S.P.A., CHIAMPO (VI) (IT)

(72) Inventors: Massimo Costantino NERESINI, CHIAMPO (VI) (IT); Andrea DALLA BENETTA, ARZIGNANO (VI) (IT); Chiara PITUELLO, VICENZA (IT); Alberto RUMIGNANI, VALDAGNO (VI) (IT); Paolo PELLIZZARI, VALDAGNO (VI) (IT)

(21) Appl. No.: 18/708,548

(22) PCT Filed: Jun. 30, 2023
(86) PCT No.: PCT/IB2023/056841

§ 371 Date: May 8, 2024

(30) Foreign Application Priority Data
Jun. 30, 2022 (IT) 102022000013891

(51) Int. Cl. A01N 63/50; A01G 22/15; A01N 59/12; A01P 21/00

(52) U.S. Cl. CPC A01N 63/50; A01G 22/15; A01N 59/12; A01P 21/00

(57) ABSTRACT

The present invention relates to a process for obtaining a composition containing a protein hydrolysate derived from collagen with high glycine content and compounds containing iodine, a composition obtained by such process, and the use of the composition as a plant bio-stimulator and/or bio-fortifier, and a process for obtaining such composition.

### TECHNICAL FIELD OF THE INVENTION

The present invention relates to a composition useful as a plant bio-stimulator and/or bio-fortifier containing a protein hydrolysate derived from collagen with high glycine content and compounds containing iodine, and to a process for obtaining such composition.

### BACKGROUND ART

Starting from collagen, an animal protein mainly present in the skin, bones, and cartilages, hydrolysates containing amino acids and peptides are obtained by a hydrolysis process, hydrolysates which are particularly rich in amino acids glycine, proline, and hydroxyproline.

The protein hydrolysates containing these amino acids have a plant bio-stimulating action and efficaciously support the plant to deal with abiotic stress such as drought, frost, excess precipitation, fast climate variations, factors increasingly impactful on crops due to climate changes. Harris Muhammad et al. “Developments for Collagen Hydrolysate in Biological, Biochemical, and Biomedical Domains: A comprehensive Review” and Ambrosini Stefano et al. “Evaluation of the potential use of a Collagen-based protein hydrolysate as a plant multi-stress protectant,” Frontiers in Plant Science, vol. 19, 2021, describe the use of protein hydrolysates as bio-stimulators.

As disclosed in WO 2017/011789 A1, glycine, due to its low molecular weight, can be absorbed by plant tissues. Proline and hydroxyproline act like osmolytes, i.e., they regulate the water potential within the plant cells, improving their response to stress.

Different nutrients, such as Mo, Mg, K, Mn, Fe, Na, Ca salts, while iodine salts are not mentioned, can be provided to plants by specific supplements as described in Santi Chiara et al. “Growth stimulatory effects and genome-wide transcriptional changes produced by protein hydrolysates in maize seedlings,” Frontiers in Plant Science, vol. 8, 2017.

However, none of these documents describes the use of a composition comprising a protein hydrolysate and components containing iodine for its supplementation in plants.

Iodine is not an essential nutrient for plants, although it is involved in different physiological and biochemical processes (Gonzali, S., Kiferle, C., and Perata, P. (2017). Iodine biofortification of crops: agronomic biofortification, metabolic engineering and iodine bioavailability. Current Opinion in Biotechnology, 44, 16-26.). The control and salt stability thereof during storage are described in Katarzyna Waskowiak et al. “Effect of storage conditions on potassium iodide stability in iodised table salt and collagen preparations,” International Journal of Food Science and Technology, vol. 43, n. 5, 2007, pages 895-899.

At low doses it has a protective effect against abiotic stress (antioxidant), while at high concentrations becomes phytotoxic and it is used in herbicide formulations.

Iodine can be absorbed from the soil through the roots, or from atmosphere through the cuticles and the leaf stomata. Iodine can be applied by foliar spray, fertirrigation or as a solid at the soil. Due to its beneficial effects on human health (contributing to the cognitive functions, the normal energetic mechanism, the functioning of the nervous system, the maintenance of a normal skin, and the production of thyroid hormones and to a normal thyroid function), the practice to enrich fresh food (for example, vegetables) with this element distributing it directly to crops (bio-fortification) has been developed. Good results were obtained on leaf vegetables (spinach, lettuce, cabbage), and some tuber vegetables or fruit crops (carrot, tomato, strawberry, and potato) (Gonzali et al., 2017). However, this strategy is poorly applicable to cereals due to the poor translocation to grain.

Further, iodine has a very complex behavior in the soil-plant system, for example the losses by volatilization are high; therefore, a slow/sustained delivery system can be advantageous (Gonzali et al., 2017).

Furthermore, different iodine sources are available for the plant supplementation thereof, including iodates, for example KIO₃, as described in Jiu-Lan Dai et al. “Selecting iodine-enriched vegetables and the residual effect of iodate application to soil”, Biological trace element research, 2004, pages 265-276.

There is still the need to find new compositions obtained by new processes able to allow an increased iodine absorption in plants.

### SUMMARY OF THE INVENTION

The invention relates to a process for the preparation of a bio-stimulant composition:
starting from the protein hydrolysate obtained from a substrate (starting material) which is a byproduct rich in collagen comprising the following steps:
a1) optional storage of the starting material;
b1) grinding with homogenization of the starting material of animal origin containing collagen and dilution with water;
c1) fat separation and removal;
d1) sterilization;
e1) one or more cycles of chemical hydrolysis;
f1) centrifugation with subsequent filtration to separate the solid residue;
g1) calcium abatement;
h1) refining;
i1) concentration;
j1) optional drying by spray-drying or granulation;
k1) optional crystallization with cooling ramp;
l1) adding of compounds containing iodine, preferably iodine salts, by mixing;
or
   starting from a protein hydrolysate obtained by a starting material which is a waste product (waste) rich in collagen comprising the following steps:
a2) optional storage of the starting material;
b2) pre-hydrolysis of the starting material;
c2) one or more cycles of hydrolysis;
d2) centrifugation with subsequent filtration to separate the solid residue;
e2) one or more cycles of pressure hydrolysis and subsequent filtration;
f2) calcium abatement;
g2) refining;
h2) concentration;
i2) optional drying by spray-drying or granulation;
j2) optional crystallization with cooling ramp;
k2) adding of compounds containing iodine, preferably iodine salts, by mixing.

The invention relates to a plant bio-stimulating composition, obtained by the process of the invention, comprising:
a protein hydrolysate derived from collagen with a glycine content higher than 5% weight/weight (w/w) on the total weight of the composition;
one or more compounds containing iodine in an amount from 0.1% w/w to 25% w/w on the total weight of the composition.

The invention relates to the use of the composition, obtained by the process of the invention, as a plant bio-stimulator and a method of bio-fortification of leaf horticultural crops comprising the foliar or root application of the composition.

### DETAILED DESCRIPTION OF THE INVENTION

It has now been found that adding compounds containing iodine to protein hydrolysates with high glycine content, it is possible to produce bio-stimulating compositions, by the process of the invention, for agricultural use wherein amino acids of natural origin act as iodine chelators in the place of synthetic molecules as the ones usually present on the market: ethylenediaminetetraacetic acid (EDTA), diethylenetriaminepentaacetic acid (DTPA), N-(2-hydroxyethyl)ethylenediaminetriacetic acid (HEDTA), or ethylenediamine-N,N′-bis-(2-hydroxyphenylacetic) acid (EDDHA).

Therefore, the compositions obtained by the process of the invention exert, in addition to a bio-stimulating function, a bio-fortification function of the crops due to the presence of iodine salts in the formulations.

Bio-fortification is a process to increase the concentration/density of vitamins and minerals in a crop by the selection of plants, transgenic techniques, or agronomic practices. The bio-fortified base crops, if consumed regularly, result in measurable improvements in the human health and nutrition (Bouis, H. E., and Saltzman, A. (2017). Improving nutrition through biofortification: a review of evidence from HarvestPlus, 2003 through 2016. Global food security, 12, 49-58.).

Bio-stimulators, as regulated by the new European Regulation in the field of fertilizers (Reg. n. 1009/2019), are substances able to stimulate the plant metabolic processes and to improve one or more of the following characteristics:
efficiency of use of nutrients,
tolerance to abiotic stress,
qualitative tracts of the production,
availability of nutrients in the soil or rhizosphere.

In fact, the compositions of the invention, obtained by the process of the invention, are able to deliver iodine inside the plant through absorption of the amino acids by leaves and/or roots (“carrier” effect). Furthermore, this system has the advantage of using natural molecules as chelating agents (differently from the synthetic origin of the almost totality of the products already on the market), which being totally biodegradable do not show drawbacks neither from an environmental point of view, nor from that of consumer safety.

The compositions of the invention, obtained by the process of the invention, allow iodine to stay in a highly available form for the plant (as a chelate), or to exploit the “carrier” effect provided by amino acids and peptides with an increase of the iodine absorption efficiency, resulting in advantages both from the environmental and the economical point of view.

Object of the present invention is therefore a bio-stimulating composition for the plant, obtained by the process of the invention, comprising:
a protein hydrolysate derived from collagen of animal origin with a total glycine content higher than 5% weight/weight (w/w) on the total weight of the composition, preferably with a free glycine content higher than 5% w/w on the total weight of the composition;
one or more compounds containing iodine, wherein iodine is present in an amount from 0.1% w/w to 25% w/w on the total weight of the composition.

According to a preferred aspect, the total glycine content ranges from 5% to 20% w/w on the total weight of the composition.

According to a further preferred aspect, the free glycine content ranges from 5% to 15% w/w on the total weight of the composition.

Preferably, the protein hydrolysate has a total nitrogen content comprised between 2% and 10% weight/weight, more preferably between 3% and 7% weight/weight on the total weight of the composition.

The compounds containing iodine are preferably selected from alkali or alkaline earth metal iodides or iodates; iodoacetic acid and salts thereof; such as potassium iodate (KIO₃); potassium iodide (KI); sodium iodate (NaIO₃); sodium iodide (NaI); iodoacetic acid (C₂H₃IO₂) and salts thereof.

More preferably, the compounds containing iodine are selected from alkali or alkaline earth metal iodides; even more preferably they are selected from potassium iodide (KI), sodium iodide (NaI), even more preferably they are potassium iodide (KI).

Therefore, object of the invention is a process for the preparation of the bio-stimulating composition starting from the protein hydrolysate obtained by a substrate (starting material) which is a byproduct rich in collagen of the invention, comprising the following steps:
a1) optional storage of the starting material;
b1) grinding with homogenization of the starting material of animal origin containing collagen and dilution with water;
c1) fat separation and removal;
d1) sterilization;
e1) one or more cycles of chemical hydrolysis;
f1) centrifugation with subsequent filtration to separate the solid residue;
g1) calcium abatement;
h1) refining;
i1) concentration;
j1) optional drying by spray-drying or granulation;
k1) optional crystallization with cooling ramp;
l1) adding of compounds containing iodine, preferably iodine salts, by mixing.

A further object of the invention is a process for the preparation of the bio-stimulating composition starting from the protein hydrolysate obtained by a starting material which is a waste product (waste) rich in collagen comprising the following steps:
a2) optional storage of the starting material;
b2) pre-hydrolysis of the starting material;
c2) one or more cycles of hydrolysis;
d2) centrifugation with subsequent filtration to separate the solid residue;
e2) one or more cycles of pressure hydrolysis and subsequent filtration;
f2) calcium abatement;
g2) refining;
h2) concentration;
i2) optional drying by spray-drying or granulation;
j2) optional crystallization with cooling ramp;
k2) adding of compounds containing iodine, preferably iodine salts, by mixing.

The protein hydrolysate of animal origin containing collagen is prepared from a starting material selected from a substrate which is a byproduct of animal origin rich in collagen or a waste product (waste) of animal origin rich in collagen by a process comprising the hereinbelow described steps.

According to the present invention, the term “animal by-product” (i.e., A.B.P.) rich in collagen means the subcutaneous tissue deriving from the scraping operations of animal skins before they are sent to the tanning operations, these operations are referred to as “fleshing,” such as the fleshing waste, as well as the residues of the animal skins before being subjected to the tanning process (for example, fur).

Fleshing is a mechanical operation aimed at removing the subcutaneous tissues and the fat in excess which remain attached to the skin during the flaying of the animal.

According to the present invention, the term “waste product” or “waste” of animal origin rich in collagen means the residue deriving from the shaving of the animal skins already subjected to the tanning process.

Animals from which the starting material is obtained can be bovines, ovines, pigs, such as calves, lambs, pigs, goats, and rams.

In step b1) grinding is preferably carried out at a temperature comprised between 4° and 80° C. and homogenization is preferably carried out at a temperature comprised between 5° and 80° C.

Step b2) of chemical pre-hydrolysis is carried out by adding water preferably in a 1:3 to 1:5 w/w ratio on the total weight of the starting material and a base selected from calcium oxide (quicklime) preferably in an amount from 8 to 15% w/w on the starting material; at a pH preferably between 10 and 13; preferably at a temperature between 8° and 120° C., more preferably between 9° and 110° C.; preferably for a time comprised between 50 and 100 minutes.

Step c1) of fat separation is preferably carried out in a centrifuge at a temperature between 7° and 100° C.

Step d1) of sterilization is preferably carried out with quicklime at a pH comprised between 9 and 12, for 3 hours, at a temperature between 75 and 100° C., followed by treatment at a temperature between 14° and 160° C., at a pressure comprised between 3.5 and 5.5 bar gauges (1.0×10⁵ Pa), for a time ranging between 30 and 50 minutes.

Step e1) and c2) of hydrolysis is preferably carried out at a pH comprised between 10 and 13, for a time ranging between 3 and 5 hours and at a temperature comprised between 9° and 110° C.

Step f1) and d2) of centrifugation is preferably carried out at a temperature comprised between 80 and 90° C.

The subsequent filtration to separate the solid residue is preferably carried out by centrifuge or rotary drum filter for f1), with plate filter for d2).

Step e2) of pressure hydrolysis is preferably carried out at a pH comprised between 10 and 13, for a time ranging between 3 and 5 hours, at a temperature comprised between 9° and 110° C.

The subsequent filtration is carried out to remove calcium carbonate.

Step h1) and g2) of refining or purification is preferably carried out with active carbon filters.

Step i1) and h2) of concentration is carried out until the mixture has a dry matter content preferably comprised between 55 and 90% w/w.

Step j1) and i2) of optional drying by spray-drying or granulation is carried out at a temperature comprised between 10° and 180° C.

Step k1) and j2) of optional crystallization with cooling ramp is carried out at a temperature from 60-90° C. to 25-0° C. for a time preferably comprised between 15 and 30 hours.

Step l1) and k2) is carried out previously dissolving the iodine compounds in hot water under stirring preferably between 5° and 60° C. The previously prepared solution of one or more compounds containing iodine is added to the protein hydrolysate, selected from alkali or alkaline earth metal iodides or iodates and iodoacetic acid and salts thereof, preferably selected from alkali or alkaline earth metals iodides, more preferably selected from potassium iodide (KI), sodium iodide (NaI), even more preferably potassium iodide (KI), keeping under stirring and heating preferably at 50-60° C., preferably for at least 1 hour. In the final composition the iodine containing salts are present in an amount ranging from 8 to 30% w/w, the protein hydrolysate is present in an amount ranging from 10 to 60%. Water is then added to obtain 100%.

The compositions according to the invention allow to improve the iodine absorption efficiency, i.e., the iodine content in food, as it will be evident from the Examples.

The refining step (or purification) is carried out with active carbon filters, preferably on a dicalite filter.

In a preferred embodiment, the starting material containing collagen is a waste product deriving from the shaving of animal skins already subjected to a tanning process, comprising the following steps:
i) dilution of the starting material with water in a 1:3 to 1:5 w/w ratio on the starting material, grinding and homogenization;
ii) chemical pre-hydrolysis with calcium oxide (quicklime) in an amount comprised between 8% and 15% w/w on the starting material at a temperature comprised between 80 and 120° C. and subsequent hydrolysis at a pH comprised between 10 and 13 for a time ranging from 3 to 5 hours at a temperature comprised between 9° and 110° C.;
iii) recovery of the protein hydrolysate obtained from the hydrolysis by purification, centrifugation, and subsequent filtration, preferably on candle filters, to separate the solid residue and remove calcium carbonate;
iv) concentration and refining with active carbon filters;
v) adding one or more compounds containing iodine;
wherein one or more compounds containing iodine are more preferably selected from alkali or alkaline earth metal iodides.

According to a preferred aspect, grinding and homogenization are carried out at a temperature comprised between 5° and 80° C.

Preferably, the starting material of animal origin containing collagen is a subcutaneous tissue deriving from the scraping operations of animal skins already subjected to a tanning process, preferably it is a fleshing waste or consists of residues of animal skins already subjected to a tanning process.

The composition according to the invention can be used as a plant bio-stimulator.

A further object of the invention is a method for the bio-fortification of leaf horticultural crops comprising the foliar or root application of the composition of the invention, obtained by the process of the invention, preferably at a dosage from 200 to 1000 g/ha.

The formulations of the invention, obtained by the process of the invention, have the following advantages:
higher stability and bioavailability in the soil-plant system, therefore higher plant absorption efficiency, due to the “carrier” effect of some amino acids towards iodine, which are thus absorbed by the plant with higher efficiency;
lower number of applications needed to obtain the desired iodine concentration in the plant;
lower iodine amount required to obtain the desired concentration in the plant;
lower treatment cost and higher environmental sustainability thereof;
obtaining a food product (for example, lettuce, strawberry and pomodoro) enriched in iodine and therefore endowed with increased nutraceutical value.

The composition according to the invention, obtained by the process of the invention, can be applied on plants by foliar spraying, or to the root apparatus by fertirrigation or nutritive solution (in the case of hydroponic or aeroponic cultivation).

### EXAMPLES

### Example 1—Preparation of the Composition (IP1)

The protein hydrolysate was prepared as hereinbelow described:
a) storage of the byproduct of animal origin;
b) dilution with water, homogenization and grinding at 60-70° C.;
oxidation/stripping of the sulphides in an oxidative environment;
acidification with sulphuric acid until pH=5-6 at 80-95° C.;
c) fat separation by centrifuge at 80-90° C.;
d) and e) sterilization and hydrolysis of the defatted slurry by adding quicklime at pH 11-12 for 3 hours at T 80-90° C., followed by treatment at T 140-150° C., pressure 3.6-5 bar gauges, for a time of 30-40 minutes as defined by the Annex 10 of EU Reg. 1069/2009;
f) filtration of the sterilized defecation gypsum;
g) calcium abatement on the broth with carbon dioxide and ammonium bicarbonate at T 70-80° C.;
h) filtration of calcium carbonate;
i) concentration until a dry matter content of 55-75%, crystallization with cooling ramp from 70-80° C. to 20-10° C. for a time t 20-24 hours;
   separation of the hydrolysate by centrifuge;
j) the iodine salts (KI) in an amount of 12% are dissolved in hot water under stirring at 50-60° C. The water amount is 31%.
k) the protein hydrolysate (IP1) is added in an amount of 57% to the KI solution, keeping stirring and heating at 50-60° C. for at least 1 hour.

The thus obtained product is characterized by:
a total glycine content equal to 9% w/w on the total weight of the composition, measured after hydrolysis with 6 N hydrochloric acid added with an antioxidant agent, followed by quantification by HPLC equipped with a fluorescence detector, on a reverse phase column, previously derivatized with o-phthalaldehyde (OPA);
a free glycine content equal to 8% w/w on the total weight of the composition, measured after hydrolysis with 0.1 N hydrochloric acid followed by quantification by HPLC equipped with a fluorescence detector, on a reverse phase column, previously derivatized with o-phthalaldehyde (OPA);
a total nitrogen content equal to 5% w/w on the total weight of the composition, measured by CNS elemental analyzer;
a total iodine content equal to 9% w/w on the total weight of the composition, measured by optical emission spectrometry preceded by an acidic mineralization step of the sample. The mineralization occurs by adding concentrated nitric acid (67-39%) and concentrated hydrochloric acid (34-37%) in a 1:3 ratio and subsequent microwave treatment at 220-250° C.

### Example 2—Preparation of the Composition (IP2)

The protein hydrolysate was prepared as hereinbelow described:
a) storage of the starting material (shaving and trimming);
b) pre-hydrolysis by addition of water in an about 1:4 w/w ratio to the starting material and quicklime (in a >10% w/w ratio to the starting material) for 90 min at T=90-100° C.;
c) hydrolysis at pH=11-12 for 3-5 hours at T 90-100° C.;
d) filtration of the solid residue containing the tanning agent;
g) refining of the broth on a dicalite filter;
e) pressure hydrolysis (with addition of further quicklime) for 2-4 hours at T 140-150° C. and P 4-5 bar gauges;
   filtration of the undissolved quicklime on candle filters;
f) calcium abatement on the broth with carbon dioxide and ammonium bicarbonate at T 70-80° C.;
   filtration of calcium carbonate;
   purification of the hydrolyzed mixture through a passage on an active carbon plant;
h) concentration until a dry matter content of 55-75%;
   crystallization with cooling ramp from 70-80° C. to 20-10° C. for a time t 20-24 hours;
   separation of the hydrolysate by centrifuge;
k) iodine salts (KI) in an amount of 23% w/w are dissolved in hot water under stirring at 50-60° C. The water amount is 51% w/w.

The thus obtained protein hydrolysate (IP2) is added in an amount of 26% to the KI solution, keeping stirring and heating at 50-60° C. for at least 1 hour.

The thus obtained product is characterized by:
a total glycine content equal to 11% w/w on the total weight of the composition, measured after hydrolysis with 6 N hydrochloric acid added with an antioxidant agent, followed by quantification by HPLC equipped with a fluorescence detector, on a reverse phase column, previously derivatized with o-phthalaldehyde (OPA);
a free glycine content equal to 10% w/w on the total weight of the composition, measured after hydrolysis with 0.1 N hydrochloric acid followed by quantification by HPLC equipped with a fluorescence detector, on a reverse phase column, previously derivatized with o-phthalaldehyde (OPA);
a total nitrogen content equal to 3.7% w/w on the total weight of the composition, measured by CNS elemental analyzer;
a total iodine content equal to 17% w/w on the total weight of the composition, measured by optical emission spectrometry preceded by an acidic mineralization step of the sample. The mineralization occurs by adding concentrated nitric acid (67-39%) and concentrated hydrochloric acid (34-37%) in a 1:3 ratio and subsequent microwave treatment at 220-250° C.

### Example 3—Efficacy Data

### Step 1: Germination

The seeds of the selected species were germinated within germination trays filled with a growth substrate composed by vernalized black peat and blond sphagnum peat (Agrofino Professional) and placed in a growth chamber.

Germination step growing conditions
07.00-12.00: T 24° C., RH 60%, Light Int. 210 μmol/m²/s;
12.00-16.00: T 25° C., RH 60%, Light Int. 280 μmol/m²/s;
16.00-20.00: T 24° C., RH 60%, Light Int. 210 μmol/m²/s;
20.00-07.00: T 23° C., RH 60%, Light Int. 0 μmol/m²/s.

The germinated seedlings were grown until the 2^{nd} real leaf stage. Later, the growth substrate portion wherein the roots were confined was extracted and a gentle washing was carried out in order to remove the whole substrate and thus obtain a free root seedling ready to be placed in hydroponics, for the test of root application. The plants were transplanted in 0.35 L pots for the foliar application test.

### Step 2a: Application of the Iodine Formulation by Root Application

The plants were grown in recipients containing 5 L of nutritive solution added with iodine salts obtained according to Example 1, or with the nutritive solution added with the formulation object of the patent. In both treatments, the applied iodine amount was the same: 36 μg I/L of nutritive solution. The plants were then grown in controlled conditions in a growth chamber:
07.00-12.00: T 24° C., RH 60%, Light Int. 300 μmol/m²/s;
12.00-16.00: T 25° C., RH 60%, Light Int. 400 μmol/m²/s;
16.00-20.00: T 24° C., RH 60%, Light Int. 300 μmol/m²/s;
20.00-07.00: T 23° C., RH 60%, Light Int. 0 μmol/m²/s.

After 15 days the plants were harvested and the aerial part was weighted. Each plant was washed with deionized water and dried in oven at 105° C. overnight. The samples were weighted, and then grinded.

The iodine content determination was performed on dried and grinded samples by optical emission spectrometry.

### Step 2b: Application of the Iodine Formulation by Foliar Application

The plants were grown for 15 days in 0.35 L pots, containing universal topsoil based on vernalized black peat and blond sphagnum, in controlled conditions in a growth chamber:
07.00-12.00: T 24° C., RH (Relative humidity) 60%, Light Int. 300 μmol/m²/s;
12.00-16.00: T 25° C., RH 60%, Light Int. 400 μmol/m²/s;
16.00-20.00: T 24° C., RH r 60%, Light Int. 300 μmol/m²/s;
20.00-07.00: T 23° C., RH 60%, Light Int. 0 μmol/m²/s.

The formulations (iodine salts and formulation object of the invention) were applied during transplantation and after 7 days, by foliar spray, delivering 5 ml of applicative solution according to Example 1 to each plant. In both treatments, the applied iodine amount was the same: 30 μg/plant. After 15 days the plants were harvested and the aerial part was weighted. Each plant was washed with deionized water and dried in oven at 105° C. overnight. The samples were weighted, and then grinded.

The iodine content determination was performed on dried and grinded samples by optical emission spectrometry.

Data were obtained on lettuce plants (Lactuca sativa L.) var. Sant′Anna.

The following was observed:

### Root Application.

Increase of the iodine absorption efficiency (49% with the formulation object of the patent versus 46% with the KI salt);
Increase of the iodine content in the food (59 μg/100 g fresh weight with the formulation object of the patent versus 55 μg/100 g fresh weight with the KI salt).

### Foliar Application

Increase of the iodine absorption efficiency (43% with the formulation object of the patent versus 40% with the KI salt);
Increase of the iodine content in the food (39 μg/100 g fresh weight with the formulation object of the patent versus 36 μg/100 g fresh weight with the KI salt).

### Example 4—Application of the Formulation of the Invention on Strawberry Plants (Fragaria×Ananassa)

The efficacy of the iodine containing formulations of the invention, in particular the iodine absorption efficiency provided by the same, was tested on strawberry plants following the foliar application and compared to that obtainable by application of an iodine salt, KI, in absence of protein hydrolysate (KI formulation).

The formulations (formulation object of the invention and KI formulation) were applied on 7 samples with 4 replicates or sub-plots (each plot corresponds to 20 m²) at the transplantation and after 10 days, by foliar spray following the scheme represented in Table 1.

TABLE 1

| | | Dosage | | Dosage | Phenological |
|---|---|---|---|---|---|
| Sample | Product | (g/ha) | | (L/ha) | phase |
| 1 | Untreated | | | | |
| 2 | Formulation | 375 | g/ha | 400-600 L/ha | From flowering |
| | of the invention | | | | |
| | (IP2) obtained | | | | |
| | according to | | | | |
| | Example 2 | | | | |
| 3 | Formulation | 3.75 | kg/ha | 400-600 L/ha | From flowering |
| | of the invention | | | | |
| | (IP2) obtained | | | | |
| | according to | | | | |
| | Example 2 | | | | |
| 4 | Formulation | 7.5 | kg/ha | 400-600 L/ha | From flowering |
| | of the invention | | | | |
| | (IP2) obtained | | | | |
| | according to | | | | |
| | Example 2 | | | | |
| 5 | KI | 85 | g/ha | 400-600 L/ha | From flowering |
| 6 | KI | 850 | g/ha | 400-600 L/ha | From flowering |

| | | | | |
|---|---|---|---|---|
| 7 | KI | ABCD | 400-600 L/ha | From flowering |

After 10 days the plants were harvested, and the aerial part was weighted. Each sample (2 Kg per sample) was washed with deionized water and dried in oven at 60° C. overnight. The samples were again weighted after drying for moisture determination, and then grinded.

The iodine content determination was performed on the dried and grinded samples by ICP-MS mass spectrometry. The results were then subsequently expressed as iodine content for 100 g of fresh weight and as % of absorbed iodine on the applied iodine.

### Example 5—Application of the Formulation of the Invention on Tomato Plants (Solanum licopersicum)

The efficacy of the formulation based on iodine of the invention, in particular the iodine absorption efficiency provided by the same, was tested on tomato plants following the foliar application and compared to that obtainable by application of an iodine salt, KI, in absence of protein hydrolysate (KI formulation).

The formulations (formulation object of the invention and KI formulation) were applied on 7 samples with 4 replicates or sub-plots (each plot corresponds to 10 m²) at the transplantation and after 10 days, by foliar spray following the scheme represented in Table 2.

TABLE 2

| | | Dosage | | Dosage | Phenological |
|---|---|---|---|---|---|
| Sample | Product | (g/ha) | | (L/ha) | phase |
| 1 | Not treated | | | | |
| 2 | Formulation | 750 | g/ha | 400-600 L/ha | From flowering |
| | of the invention | | | | |
| | (IP2) obtained | | | | |
| | according to | | | | |
| | Example 2 | | | | |
| 3 | Formulation | 3.75 | kg/ha | 400-600 L/ha | From flowering |
| | of the invention | | | | |
| | (IP2) obtained | | | | |
| | according to | | | | |
| | Example 2 | | | | |
| 4 | Formulation | 7.5 | kg/ha | 400-600 L/ha | From flowering |
| | of the invention | | | | |
| | (IP2) obtained | | | | |
| | according to | | | | |
| | Example 2 | | | | |
| 5 | KI | 175 | g/ha | 400-600 L/ha | From flowering |
| 6 | KI | 875 | g/ha | 400-600 L/ha | From flowering |
| 7 | KI | 1.75 | kg/ha | 400-600 L/ha | From flowering |

After 10 days the plants were harvested, and the aerial part was weighted. Each sample (2 Kg per sample) was washed with deionized water and dried in oven at 60° C. overnight. The samples were again weighted after drying for moisture determination, and then grinded.

The iodine content determination was performed on the dried and grinded samples by ICP-MS mass spectrometry. The results were then subsequently expressed as iodine content for 100 g of fresh weight and as % of absorbed iodine on the applied iodine.

1. A process for the preparation of a bio-stimulating composition starting from the protein hydrolysate obtained by a substrate (starting material) which is a byproduct rich in collagen, comprising the following steps:
a1) optional storage of the starting material;
b1) grinding with homogenization of the starting material of animal origin containing collagen and dilution with water;
c1) fat separation and removal;
d1) sterilization;
e1) one or more cycles of chemical hydrolysis;
f1) centrifugation with subsequent filtration to separate the solid residue;
g1) calcium abatement;
h1) refining;
i1) concentration;
j1) optional drying by spray-drying or granulation;
k1) optional crystallization with cooling ramp;
l1. adding of compounds containing iodine, preferably iodine salts, by mixing.

2. A process for the preparation of a bio-stimulating composition starting from a protein hydrolysate obtained by a starting material which is a waste product (waste) rich in collagen, comprising the following steps:
a2) optional storage of the starting material;
b2) pre-hydrolysis of the starting material;
c2) one or more cycles of hydrolysis;
d2) centrifugation with subsequent filtration to separate the solid residue;
e2) one or more cycles of pressure hydrolysis and subsequent filtration;
f2) calcium abatement;
g2) refining;
h2) concentration;
i2) optional drying by spray-drying or granulation;
j2) optional crystallization with cooling ramp;
k2) adding of compounds containing iodine, preferably iodine salts, by mixing.

3. A process according to claim 1, wherein in step b1) grinding is carried out at a temperature comprised between 4° and 80° C. and homogenization is carried out at a temperature comprised between 5° and 80° C.

4. A process according to claim 2, wherein step b2) of chemical pre-hydrolysis is carried out by adding water in a 1:3 to 1:5 w/w ratio on the total weight of the starting material and a base selected from calcium oxide (quicklime) in an amount from 8 to 15% w/w on the starting material; at a pH preferably between 10 and 13; at a temperature between 8° and 120° C., preferably between 9° and 110° C.; for a time comprised between 50 and 100 minutes.

5. A process according to claim 1, wherein step c1) of fat separation is carried out in centrifuge at a temperature between 7° and 100° C.

6. A process according to claim 1, wherein step d1) of sterilization is carried out with quicklime at a pH comprised between 9 and 12, for 3 hours, at a temperature between 75 and 100° C., followed by treatment at a temperature between 14° and 160° C., at a pressure comprised between 3.5 and 5.5 bar gauges (1.0×10⁵ Pa), for a time ranging between 30 and 50 minutes.

7. A process according to claim 1, wherein step e1) and c2) of hydrolysis is carried out at pH comprised between 10 and 13, for a time ranging between 3 and 5 hours and at a temperature comprised between 9° and 110° C.

8. A process according to claim 1, wherein step f1) and d2) of centrifugation is carried out at a temperature comprised between 8° and 90° C.

9. A process according to claim 2, wherein step e2) of pressure hydrolysis is carried out at a pH comprised between 10 and 13, for a time ranging between 3 and 5 hours, at a temperature comprised between 9° and 110° C.

10. A process according to claim 1, wherein step i1) and h2) of concentration is carried out until the mixture has a dry matter content comprised between 55 and 90% w/w.

11. A process according to claim 1, wherein step j1) and k2) is carried out previously dissolving the iodine compounds from 8 to 30% w/w of the bio-stimulating composition in hot water under stirring preferably between 5° and 60° C. to obtain a solution.

12. A process according to claim 11, wherein a solution of compounds containing iodine, preferably iodine salts, more preferably KI, is added to the protein hydrolysate in an amount ranging from 10% to 60% w/w on the bio-stimulating composition, keeping under stirring and heating preferably at 50-60° C., preferably for at least 1 hour.

13. A process according to claim 1, wherein the starting material of animal origin containing collagen is a subcutaneous tissue deriving from the scraping operations of animal skins already subjected to a tanning process, preferably is a fleshing waste or it consists of residues of animal skins already subjected to a tanning process.

14. A process according to claim 1, wherein one or more compounds containing iodine are selected from alkali or alkali earth metal iodides or iodates and iodoacetic acid and salts thereof.

15. A process according to claim 14, wherein one or more compounds containing iodine are selected from alkali or alkali earth metal iodides, preferably are selected from potassium iodide (KI), sodium iodide (NaI).

16. A plant bio-stimulating composition obtained according to the process of claim 1, comprising:
a protein hydrolysate derived from collagen with a glycine content higher than 5% weight/weight (w/w) on the total weight of the composition;
one or more compounds containing iodine in an amount from 0.1% w/w to 25% w/w on the total weight of the composition.

17. A composition according to claim 16, wherein one or more compounds containing iodine are selected from alkali or alkali earth metal iodides or iodates and iodoacetic acid and salts thereof.

18. A composition according to claim 17, wherein one or more compounds containing iodine are selected from alkali or alkali earth metal iodides, preferably are selected from potassium iodide (KI), sodium iodide (NaI).

19. A composition according to claim 16, wherein the protein hydrolysate has a total glycine content comprised between 5% and 20% w/w on the total weight of the composition.

20. A composition according to claim 19, wherein the protein hydrolysate has a total nitrogen content comprised between 2% and 10% weight/weight, more preferably between 3% and 7% weight/weight on the total weight of the composition.

21. Use of the composition according to claim 16 as a plant bio-stimulator.

22. A method of bio-fortification of leaf horticultural crops comprising the foliar or root application of the composition according to claim 16.
